(19) United States
(12) Patent Application Publication
(10) Pub. No.: US 2014/0324282 A1
(43) Pub. Date: Oct. 30, 2014

(54) METHOD AND DEVICE FOR MONITORING A DRIVE OF A DRIVE SYSTEM OF A VEHICLE

(71) Applicants: Markus Praher, Leopoldsdorf (DE); Johannes Richter, Wien (AT); Uwe Rinker, Kornwestheim (DE)

(72) Inventors: Markus Praher, Leopoldsdorf (DE); Johannes Richter, Wien (AT); Uwe Rinker, Kornwestheim (DE)

(21) Appl. No.: 14/000,550

(22) PCT Filed: Feb. 1, 2012
(86) PCT No.: PCT/EP12/51687

§ 371 Date: Dec. 27, 2013

(30) Foreign Application Priority Data
Feb. 25, 2011 (DE) 10 2011 004 773.5

(51) Int. Cl. F02D 7/00; F02D 28/00

(52) U.S. Cl. CPC F02D 7/00; F02D 28/00
USPC 701/33.9

(57) ABSTRACT

A method for monitoring a drive system of a vehicle for faults, the drive system having a drive engine which provides a torque depending on an injected fuel amount, includes the following steps: carrying out a threshold value comparison between a variable ascertained from information about an injected fuel amount and a threshold value ascertained from rotational speed information about the rotational speed of the drive engine; and ascertaining fault information indicating a fault in the drive system, depending on the result of the threshold value comparison.

### BACKGROUND OF THE INVENTION

1. Field of the Invention

The present invention relates to drive systems for vehicles, in particular to methods for monitoring drives for faults that may result in undesirable acceleration of the vehicle.

2. Description of the Related Art

A multitude of engine functions of an internal combustion engine are carried out in an engine control unit controlling the internal combustion engine. In the case of computing errors, bit flips and the like, faulty output may arise in non-fail-safe engine control units, which in the worst case may result in undesirable acceleration in the vehicle complex, for example due to injection of an excessive fuel amount. Since such faults may jeopardize people in road traffic, it is necessary for the engine control unit to detect faults automatically and place the vehicle into a safe state.

To prevent the occurrence of such faults from resulting in torque changes, continuous torque monitoring is implemented in the engine control unit. Conventional concepts for monitoring the engine control units with respect to such a fault are as follows:
Coasting monitoring: This is used to check that the internal combustion engine does not generate any propulsion-relevant drive torque when the driver does not signal any propulsion input.
Torque monitoring: The instantaneous drive torque, which is obtained by back-calculating observed variables, is compared to the redundantly read-in driver input in accordance with a driver's specification.
Acceleration monitoring: The instantaneous vehicle acceleration derived from the vehicle velocity is compared to an acceleration that results from the redundantly provided driver input torque.

Sole coasting monitoring is no longer part of the related art these days, since here only one operating point, namely the operating point of the coasting operation, is being monitored. However, since coasting monitoring may only be carried out during a coasting operation, generally a delay occurs in the monitoring response until the next coasting operation. A fault that occurs when the internal combustion engine is not in a coasting operation would therefore only be detected with a delay. As a result, the torque monitoring and acceleration monitoring concepts are generally provided on a supplementary basis for coasting monitoring.

In diesel engines, the coasting monitoring concept may be carried out in a simple manner by checking whether or not the internal combustion engine generates a propulsion-relevant drive torque by monitoring the injected fuel amount. During coasting operation, no fuel should be injected in a diesel engine. Such a method cannot be applied to gasoline engines since in gasoline engines the fuel metering is dependent on the present air charge in the cylinders.

However, the concept of coasting monitoring has the advantage that the complexity for monitoring this operating range is drastically reduced due to simplifications, since very precise target specifications may be checked.

In addition, coasting monitoring as it is known from these engines may not be readily applied to gasoline engines due to torque-forming amounts of fuel that are also supplied during a coasting operation. Torque-requiring components are also active during coasting operation in gasoline engines and may require injections of fuel. This is the case during transmission interventions and during an operating mode for heating the catalytic converter, for example. When torque-requiring components are activated during coasting operation, the coasting operation state is briefly interrupted and coasting monitoring would have to be deactivated during this time. However, the additional torque-requiring components do not act on the vehicle in an accelerating manner since they only provide additional torque, which is necessary to operate a power unit, such as an air conditioner, the alternator or the like, for example.

Due to the requirements in regard to exhaust gas after-treatment, fuel is injected during coasting operation to an increasing extent during the coasting operation of gasoline engines, so that conventional coasting monitoring may not be usefully employed in gasoline engines. While also no relevant drive torque forms during these injections since the energy of the injected fuel is discharged torque-neutral as a thermal exhaust gas flow, it is not possible, however, to disregard this additional injection amount during coasting monitoring.

In conjunction with a suitable monitoring concept, it is necessary to monitor driving in coasting mode in certain driving situations.

### BRIEF SUMMARY OF THE INVENTION

It is therefore an object of the present invention to make monitoring of the vehicle with respect to undesirable acceleration during coasting operation available, in particular also for vehicles having gasoline engines.

According to a first aspect, a method for monitoring a drive system of a vehicle for faults is provided, the drive system having a drive engine, which supplies a torque depending on an injected fuel amount. The method includes the following steps:
carrying out a threshold value comparison between a variable ascertained from information about an injected fuel amount and a threshold value ascertained from rotational speed information about the rotational speed of the drive engine; and
ascertaining fault information indicating a fault in the drive system, depending on the result of the threshold value comparison.

The above-mentioned method for monitoring a drive system of a vehicle allows faulty computations, which may result in undesirable acceleration or deceleration of the motor vehicle, to be detected by conducting a plausibility check based on monitoring of the rotational speed. For this purpose, a threshold value is assigned to the rotational speed of the drive engine, the value representing an upper limit for a variable ascertained from the injected fuel amount. The plausibility of the rotational speed of the engine in relation to the injected fuel amount may thus be checked, and a fault may be detected if the rotational speed is higher than a rotational speed that would be expected for an injected fuel amount during coasting operation.

The monitoring of the rotational speed generated by the drive torque of the internal combustion engine described above may eliminate the complex computation of the drive torque.

If a coasting operation of the vehicle is established in which a drive of the vehicle should not provide any drive torque, the fault information may in particular be made available for a downstream function.

In addition, it may be provided that the threshold value comparison is carried out by the fact that from the information about the injected fuel amount, information about a torque at an optimal ignition angle is determined, the information about the torque at an optimal ignition angle being multiplied with efficiency information to obtain a comparison variable, the comparison variable being compared to a threshold value to obtain the fault information.

According to one specific embodiment, the information about a torque at an optimal ignition angle may be determined from the information about the injected fuel amount with the aid of predefined fuel amount characteristics.

In addition, the efficiency information may be determined based on information about an ignition angle with the aid of predefined ignition angle efficiency characteristics.

It may be provided that the threshold value is determined from the rotational speed information with the aid of predefined rotational speed characteristics.

In addition, the information about the injected fuel amount and the rotational speed information may be supplied as reliable variables, which have been checked for accuracy according to a plausibility checking method.

According to a further aspect, a monitoring device for monitoring a drive system of a vehicle for faults is provided, the drive system having a drive engine, which supplies a torque depending on an injected fuel amount, the monitoring device being designed to:
carry out a threshold value comparison between a variable ascertained from information about an injected fuel amount and a threshold value ascertained from rotational speed information about the rotational speed of the drive engine; and
to ascertain fault information indicating a fault in the drive system, depending on the result of the threshold value comparison.

According to a further aspect, a drive system for a vehicle is provided, including:
a drive engine for driving the vehicle;
an engine control unit for controlling the drive engine; and
the above-mentioned monitoring unit.

According to a further aspect, a computer program product is provided, which includes a program code that carries out the above-mentioned method when the code is executed on a data processing unit.

### BRIEF DESCRIPTION OF THE DRAWINGS

FIG. 1 shows a schematic illustration of a vehicle, including a device for monitoring drive faults during coasting operation.

FIG. 2 shows a function diagram to illustrate a method for carrying out coasting monitoring in a motor vehicle.

### DETAILED DESCRIPTION OF THE INVENTION

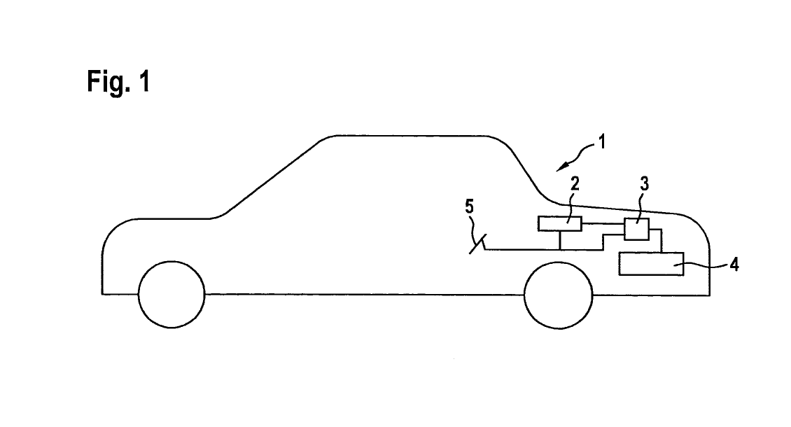

FIG. 1 shows a schematic illustration of a motor vehicle 1 having a monitoring device 2 for monitoring a drive system for faults, such as faults of an engine control unit. Monitoring device 2 is connected to an engine control unit 3, which controls a drive engine 4, in particular a gasoline engine. Monitoring device 2 may also be implemented in engine control unit 3.

Engine control unit 3 is also connected to a gas pedal 5 to record information about a gas pedal position and associate this with a driver input torque. Engine control unit 3 is further designed to control drive engine 4 in accordance with the driver input torque, so that the engine supplies a drive torque for the propulsion of vehicle 1 which essentially corresponds to the driver input torque.

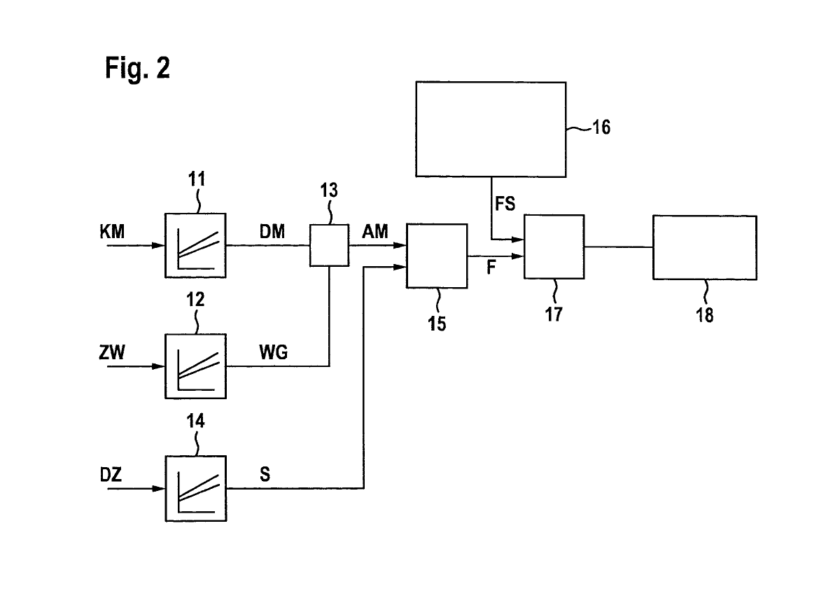

Monitoring device 2 is used primarily for monitoring the drive of drive engine 4 during coasting operation. For this purpose, monitoring device 2 carries out the method for monitoring for drive faults, as is illustrated by the function diagram of FIG. 2.

The function illustrated in FIG. 2 may be characteristic map-based, and a variable that is dependent on the injected fuel amount is compared to a threshold value that is dependent on a rotational speed of drive engine 4. A fault correction function is called up as soon as the variable that is dependent on the fuel amount exceeds the threshold value.

For this purpose, information about instantaneously injected fuel amount KM is converted into a fuel amount variable DM in an injection fuel amount characteristics block 11 with the aid of predefined fuel amount characteristics. Fuel amount variable DM may indicate the drive torque at an optimal ignition angle.

In an ignition angle efficiency characteristics block 12, information that is provided in engine control unit 3 about an ignition angle ZW at which the combustions in the cylinders of drive engine 4 take place is converted into an ignition angle efficiency WG with the aid of predefined ignition angle efficiency characteristics. Deviations from an optimal ignition angle lower the efficiency of the supplied torque.

The fuel amount variable DM is multiplied in a multiplier 13 with the ignition angle efficiency WG to obtain a comparison variable AM. Comparison variable AM may correspond to a modeled instantaneous drive torque.

Provided rotational speed information DZ is converted into a threshold value S in a rotational speed characteristics block 14 with the aid of rotational speed characteristics. In a comparison block 15, instantaneous drive torque AM is compared to threshold value S, and fault information F indicates whether the modeled instantaneous drive torque AM is greater than threshold value S.

The monitoring should only be carried out if certain enabling conditions exist. The existence of the enabling conditions is ascertained in an enabling block 16.

It is established in particular in enabling block 16 that a coasting operation exists and no further torque-increasing intervention takes place. In detail, one or multiple of the following criteria may be checked to meet the enabling conditions.
The lambda value corresponds to 1, i.e., the air/fuel ratio is in stoichiometric balance, or to a predefined value, for example 0.95.
A coasting operation exists, i.e., the driver specifies a gas pedal angle of 0, and thus a driver input torque of 0, by not operating a gas pedal.
No rotational speed control is active, such as the idle speed control.
No torque-increasing transmission intervention is taking place.
No torque-increasing driving stability intervention is taking place.
No torque-increasing cruise control intervention is taking place.
Ancillary units are not requiring any increase in the drive torque.

If the enabling conditions that are checked in enabling block 16 are met, enabling for monitoring during a coasting operation is activated, so that fault information F is forwarded to substitute function block 18 as soon as the enabling conditions are met. Emergency operation, which is provided for the occurrence of a monitored fault, is activated in substitute function block 18. The emergency operation may include an emergency operating mode or deactivation of internal combustion engine 4, for example. For example, substitute function block 18 may no longer allow engine speeds above a threshold that is applied by rotational speed characteristics 14.

In addition, fault information F may be debounced, so that short-term instances where threshold value S is exceeded by the instantaneous drive torque remain unconsidered.

The variables that are supplied to characteristics blocks 11, 12, 14, the information about fuel amount KM, the information about ignition angle ZW, and the rotational speed information are monitored variables, which are present as reliable variables in engine control unit 3 in accordance with a 3-stage security concept. This means that the accuracy of the variables has already been assured by other plausibility algorithms.

Activating the monitoring of the drive system with the aid of enabling block 16 may also be implemented elsewhere in the function. For example, comparison block 15 and characteristics blocks 11, 12, 14 may be activated depending on an enabling signal FS. It is essential that the monitoring function is only active when the enabling conditions are met.

1-10. (canceled)

11. A method for monitoring a drive system of a vehicle for faults, the drive system having a drive engine supplying a torque which depends on an injected fuel amount, the method comprising:
carrying out a threshold value comparison between a variable ascertained from information about an injected fuel amount and a threshold value ascertained from rotational speed information about the rotational speed of the drive engine; and
ascertaining fault information indicating a fault in the drive system, based on the result of the threshold value comparison.

12. The method as recited in claim 11, wherein the ascertained fault information is forwarded to a control element for triggering a response action only if a coasting operation of the vehicle is determined, in which a drive of the vehicle does not provide any drive torque.

13. The method as recited in claim 12, wherein the threshold value comparison is performed by:
determining information about a torque at an optimal ignition angle, based on the information about the injected fuel amount;
multiplying the information about the torque at an optimal ignition angle by efficiency information to obtain a comparison variable; and
comparing the comparison variable to the threshold value to obtain the fault information.

14. The method as recited in claim 13, wherein the information about a torque at an optimal ignition angle is determined from the information about the injected fuel amount with the aid of predefined fuel amount characteristics.

15. The method as recited in claim 13, wherein the efficiency information is determined from information about an ignition angle with the aid of predefined ignition angle efficiency characteristics.

16. The method as recited in claim 13, wherein the threshold value is determined from the rotational speed information with the aid of predefined rotational speed characteristics.

17. The method as recited in claim 13, wherein the information about the injected fuel amount and the rotational speed information are provided as variables which have been checked for accuracy according to a plausibility checking method.

18. A monitoring device for monitoring a drive system of a vehicle for faults, the drive system having a drive engine which provides a torque depending on an injected fuel amount, comprising:
means for carrying out a threshold value comparison between a variable ascertained from information about an injected fuel amount and a threshold value ascertained from rotational speed information about the rotational speed of the drive engine; and
means for ascertaining fault information indicating a fault in the drive system, based on the result of the threshold value comparison.

19. A non-transitory computer-readable data storage medium storing a computer program having program codes which, when executed on a computer, performs a method for monitoring a drive system of a vehicle for faults, the drive system having a drive engine supplying a torque which depends on an injected fuel amount, the method comprising:
carrying out a threshold value comparison between a variable ascertained from information about an injected fuel amount and a threshold value ascertained from rotational speed information about the rotational speed of the drive engine; and
ascertaining fault information indicating a fault in the drive system, based on the result of the threshold value comparison.
